(19) United States
(12) Patent Application Publication
(10) Pub. No.: US 2003/0115479 A1
(43) Pub. Date: Jun. 19, 2003

(54) Method and system for detecting computer malwares by scan of process memory after process initialization

(76) Inventors: Jonathan Edwards, Portland, OR (US); Shawna Turner, Portland, OR (US); Joel Spurlock, Portland, OR (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/014,874

(22) Filed: Dec. 14, 2001

(51) Int. Cl. G06F 11/30

(52) U.S. Cl. 713/200

(57) ABSTRACT

A method, system, and computer program product for detecting a malware that provides the capability to detect malwares included in compressed files or which require emulation. A method of detecting a malware comprises the steps of scanning a process that has been loaded for execution for a malware, allowing the process to execute, if no malware is found, interrupting execution of the process, and scanning the process for a malware.

### FIELD OF THE INVENTION

The present invention relates to a method, system, and computer program product for detecting computer malwares by scanning process memory after initialization of the suspect process.

### BACKGROUND OF THE INVENTION

As the popularity of the Internet has grown, the proliferation of computer malware has become more common. A typical computer malware is a program or piece of code that is loaded onto a computer and/or performs some undesired actions on a computer without the knowledge or consent of the computer operator. The most widespread, well-known and dangerous type of computer malware are computer viruses, that is, programs or pieces of code that replicate themselves and load themselves onto other connected computers. Once the virus has been loaded onto the computer, it is activated and may proliferate further and/or damage the computer or other computers.

Along with the proliferation of computer viruses and other malware has come a proliferation of software to detect and remove such viruses and other malware. This software is generically known as anti-virus software or programs. In order to detect a virus or other malicious program, an anti-virus program typically scans files stored on disk in a computer system and/or data that is being transferred or downloaded to a computer system, or that is being accessed on a computer system, and compares the data being scanned with profiles that identify various kinds of malware. The anti-virus program may then take corrective action, such as notifying a user or administrator of the computer system of the virus, isolating the file or data, deleting the file or data, etc.

Typically, computer viruses are transmitted in infected executable files or files that contain macros. Executable files include executable code that is intended to be run on a computer system. Thus, anti-virus programs typically scan executable files in order to find viruses. However, many software programs include files, such as executable files, that are compressed, in order to conserve disk space. A file that is in a compressed format is known as a packed file. For example, as shown in FIG. 1, anti-virus program 102, which includes virus scanning routines 104 and virus removal routines 106, scans application program files 108A-Z. Together, application program files 108A-Z are used by application program 110 to provide the executable code and data that are required to run application program 110. Some of the application program files, such as application program files 108C-Z, are compressed using a format that consumes less storage space than the uncompressed format.

In order to find a virus or other malware in a compressed file, anti-virus program 102 must decompress the compressed file and scan the uncompressed version of the file. A problem arises in that the decompression or unpacking step adds overhead to the virus detection process. An additional problem arises in that many application programs use proprietary compression or packing formats and new packing formats are frequently introduced. Since the anti-virus program must decompress or unpack files before viruses can be detected, the introduction of a packing format that is not supported by the anti-virus program makes detection of viruses in files using that packing format impossible.

Yet another problem arises in the context of new processor architectures that require that the anti-virus program emulate the instruction set of the new processor architecture. If viruses or other malwares are introduced that are compiled to natively run on a new processor architecture and if the virus requires emulation in order to be detected, such as a virus that polymorphically encrypts itself when it infects a new host, the anti-virus program may not reliably detect the virus.

A need arises for a technique by which viruses or other malwares included in compressed files or which require emulation can reliably be detected.

### SUMMARY OF THE INVENTION

The present invention is a method, system, and computer program product for detecting a malware that provides the capability to detect malwares included in compressed files or which require emulation. In one embodiment of the present invention, a method of detecting a malware comprising the steps of interrupting the execution of a process that has been loaded for execution, scanning the process's memory for a malware and allowing the process to execute if no malware is found or terminating execution of the process if a malware is found.

The process may be associated with an application program. The process may be loaded from at least one compressed, packed, or encrypted file. The process may comprise the step of loading code for execution by the process from at least one compressed, packed, or encrypted file. The step of interrupting execution of the process may comprise the step of interrupting execution of the process when the process accesses at least one file that is not needed to perform decryption, decompression, or unpacking. The at least one file that is not needed to perform decryption, decompression, or unpacking may comprise a system library file. The at least one file that is not needed to perform decryption, decompression, or unpacking may comprise an executable file not related to the process. The at least one file that is not needed to perform decryption, decompression, or unpacking may comprise a data file not related to the process. The malware may be a computer virus, a computer worm, or a Trojan horse program.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an prior art data flow diagram of information processed by a prior art anti-virus program.

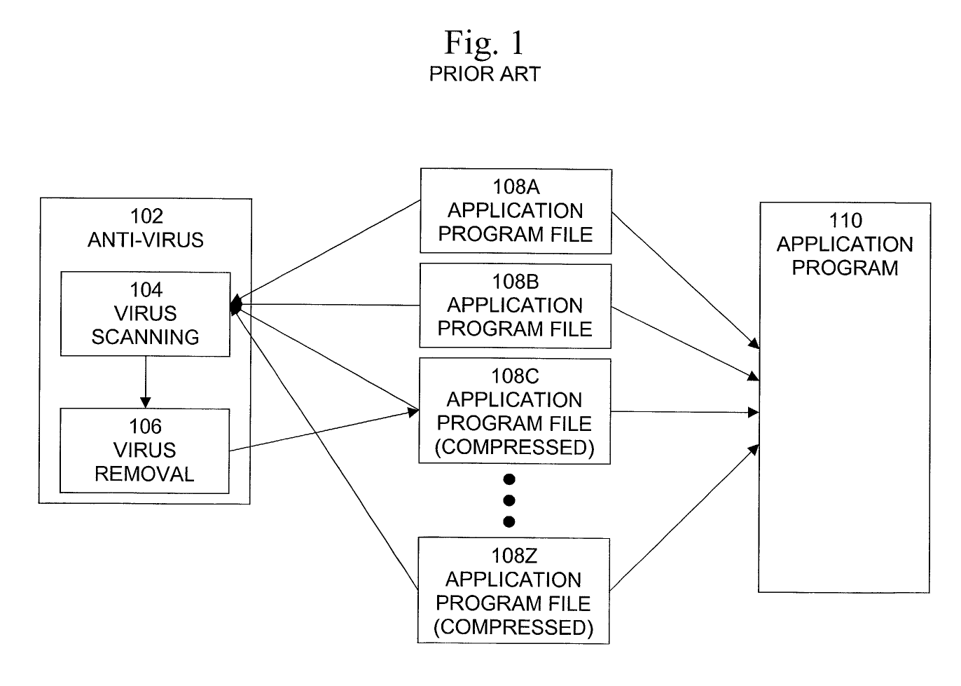

FIG. 2 is an exemplary data flow diagram of information processed by the present invention.

FIG. 3 is a block diagram of an exemplary computer system, in which the present invention may be implemented.

FIG. 4 is an exemplary flow diagram of a file scanning process, which may be implemented in the system shown in FIG. 3.

### DETAILED DESCRIPTION OF THE INVENTION

A typical computer malware is a program or piece of code that is loaded onto a computer and/or performs some undesired actions on a computer without the knowledge or consent of the computer operator. Types of malware include computer viruses, Trojan horse programs, and other content. One widespread, well-known and dangerous type of computer malware are computer viruses, that is, programs or pieces of code that replicate themselves and load themselves onto other connected computers. Once the virus has been loaded onto the computer, it is activated and may proliferate further and/or damage the computer or other computers. A particular type of computer virus is the computer worm, which is a program or code that replicates itself over a computer network and may perform malicious actions, such as using up the computer's resources and possibly shutting the system down. A Trojan horse program is typically a destructive program that masquerades as a benign application. Unlike a virus, Trojan horses do not replicate themselves but they can be just as destructive. One insidious type of Trojan horse is a program that claims to rid a computer of malwares but instead introduces malwares onto the computer. Although terms such as virus or anti-virus may be used for clarity, such terms are used only as example of malwares and the present invention contemplates any and all types of malware, including, but not limited to computer viruses, computer worms, Trojan horse programs.

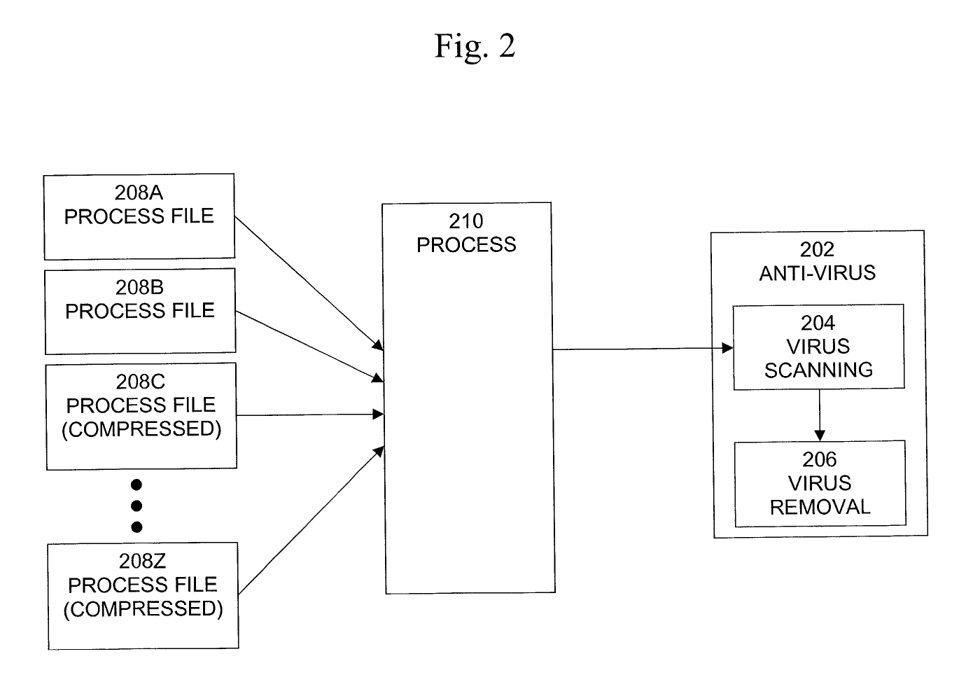

An exemplary data flow diagram of information processed by the present invention is shown in FIG. 2. As shown in FIG. 2, an anti-virus program 202 includes virus scanning routines 204 and virus removal routines 206. A plurality of process files 208A-Z are used by process 210. Process 210 typically includes the combination of a program being executed and bookkeeping information used by the operating system. Whenever a program is executed, the operating system creates a new process or task for it. The task is like an envelope for the program: it identifies the program with a task number and attaches other bookkeeping information to it. Many operating systems, including UNIX, OS/2, and Windows, are capable of running many tasks at the same time and are called multitasking operating systems. In most operating systems, there is a one-to-one relationship between the task and the program, but some operating systems allow a program to be divided into multiple tasks. Such systems are called multithreading operating systems.

Process files 208A-Z include executable code and data that are used to create and support the execution of process 210 in main memory of a computer system. Some process files, such as process files 208A and 208B may include uncompressed or unencrypted code and/or data, while other process files, such as process files 208C-Z may include encrypted code or compressed or packed code and/or data. Initially, the operating system loads the contents of one or more process files 208A-Z into main memory, decompressing or unpacking compressed process files as necessary. Once an initial amount of executable code has been loaded into main memory, and the appropriate bookkeeping information has been generated, the operating system may initiate execution of the loaded code, creating process 210.

Once the initial amount of executable code has been loaded into main memory, anti-virus program 202 may scan the areas or areas in main memory that are included in process 210, in order to determine whether there are any viruses or other malwares present. This would be useful if the initial executable code for process 210 was stored in a compressed format. If process 210 is clean, that is, there are no viruses present in the main memory areas included in process 210, then anti-virus program 202 allows execution of process 210 to be initiated.

If the initial executable code for process 210 was not stored in a compressed format, this initial scan would be less useful because anti-virus program 202 would likely have scanned the files in which the initial executable code for process 210 was stored and detected any malwares included in the file. Thus, for initial executable code for process 210 that was not stored in a compressed format, the initial scan would likely always be negative. In this case, scanning performed after process 210 has executed for a time would likely be more useful.

Once execution of process 210 has begun, process 210 may load the contents of other process files 208A-Z into main memory. For those process files that are compressed, such as process files 208C-Z, the file contents will be decompressed or unpacked, and in some cased decrypted, before the file contents are available in main memory. Since the process files may contain viruses or other malwares, process 210 will be interrupted one or more times at a point at which it is likely that any decryptors and decompressors have run and loaded the file contents into main memory, but at a point before any malwares in the loaded code have had a chance to perform any malicious or unauthorized actions. Once process 210 is interrupted, anti-virus program 210 will use virus scanning routines 204 to scan the memory space of process 210 for viruses or other malware using existing or new memory scanning techniques. For example, virus scanning routines 204 may scan MICROSOFT MSDOS® memory as well as 32 bit and 64 bit memory under MICROSOFT WINDOWS 95® and MICROSOFT WINDOWS NT®. The decrypted or decompressed code must be present in the memory space of process 210, which enhances the likelihood of finding any virus or other malware that is present. If process 210 is found to include a virus or other malware, then process 210 can be terminated. This is equivalent to preventing the process from executing at all had the initial scan of process 210 or if the initial scan of the file on the disk had found the virus.

One possible point at which any decryption, decompression, or unpacking have been completed, and the process's normal execution is about to start, is when the process accesses files that are not needed to perform the decryption, decompression, or unpacking. For example, these files could be system libraries that a back door Trojan horse program may use to establish a communication link with another computer. As another example, the files could be executable files not related to the process, such as files related to other application programs or processes, that a virus is about to infect. Files that process 210 is allowed to access will be those files that all processes access, or those that are determined to be safe. These characteristics will be determined on case by case basis depending upon the operating system in use.

The process of analyzing file system activity to determine when it will be useful to scan a process's memory space can be added to existing on-access file scanning of anti-virus programs. The on-access scan monitors when processes start and sees all the file activity performed by all processes in the system. The on-access scan is thus in an ideal position to scan a process's memory space.

Other techniques can be used to determine when it will be useful to scan a process's memory space. For example, a scan may be initiated when process 210 attempts to access system configuration data, such as the WINDOWS® registry. As another example, a scan may be initiated when process 210 attempts to establish a network or other communication connection.

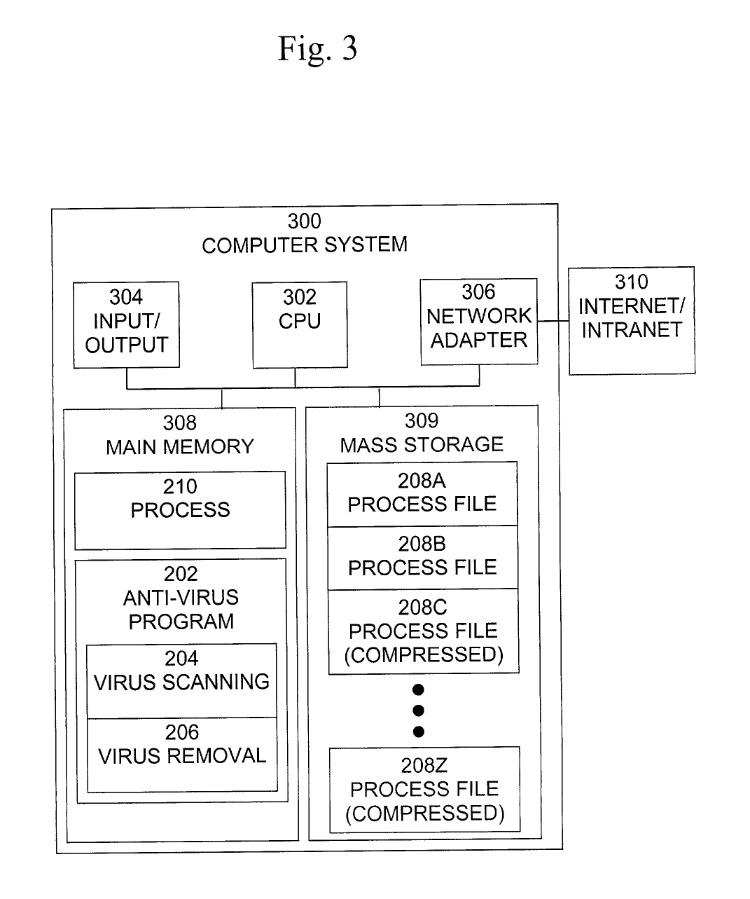

A block diagram of an exemplary computer system 300, in which the present invention may be implemented, is shown in FIG. 3. Computer system 300 is typically a programmed general-purpose computer system, such as a personal computer, workstation, server system, and minicomputer or mainframe computer. Computer system 300 includes processor (CPU) 302, input/output circuitry 304, network adapter 306, and memory 308. CPU 302 executes program instructions in order to carry out the functions of the present invention. Typically, CPU 302 is a microprocessor, such as an INTEL PENTIUM® processor, but may also be a minicomputer or mainframe computer processor. Although in the example shown in FIG. 3, computer system 300 is a single processor computer system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which computer system 300 is implemented on a plurality of networked computer systems, which may be single-processor computer systems, multi-processor computer systems, or a mix thereof.

Input/output circuitry 304 provides the capability to input data to, or output data from, computer system 300. For example, input/output circuitry may include input devices, such as keyboards, mice, touchpads, trackballs, scanners, etc., output devices, such as video adapters, monitors, printers, etc., and input/output devices, such as, modems, etc. Network adapter 306 interfaces computer system 300 with Internet/intranet 310. Internet/intranet 310 may include one or more standard local area network (LAN) or wide area network (WAN), such as Ethernet, Token Ring, the Internet, or a private or proprietary LAN/WAN.

Main memory 308 stores program instructions that are executed by, and data that are used and processed by, CPU 302 to perform the functions of computer system 300. Memory 308 typically includes electronic memory devices, such as random-access memory (RAM), which are capable of high-speed read and write operations providing direct access by the CPUs 302A-N. Additional memory devices included in computer system 300 may include read-only memory (ROM), programmable read-only memory (PROM), electrically erasable programmable read-only memory (EEPROM), flash memory, etc. Mass storage 309 may include electromechanical memory, such as magnetic disk drives, such as hard disk drives and floppy disk drives, tape drives, optical disk drives, etc., which may use one or more standard or special purpose interfaces.

Main memory 308 includes process 210 and anti-virus program 202. Process 210 is a process that is monitored and scanned by anti-virus program 202. Anti-virus program 202 includes virus scanning routines 204 and virus removal routines 206. Anti-virus program 202 uses virus scanning routines 204 to scan the areas or areas in main memory that are included in process 210, in order to determine whether there are any viruses or other malwares present. If a virus or other malware is found, anti-virus program uses virus removal routines 206 to respond by performing actions such as terminating process 210, quarantining files, cleaning files, deleting files, etc.

Mass storage 309 includes process files 208A-Z. Process files 208A-Z include executable code and data that are used to created and support the execution of process 210 in main memory 308. Some process files, such as process files 208A and 208B may include uncompressed code and/or data, while other process files, such as process files 208C-Z may include compressed or packed code and/or data. An operating system (not shown) provides overall system functionality, including actually performing the paging as determined by memory pressure routines 320.

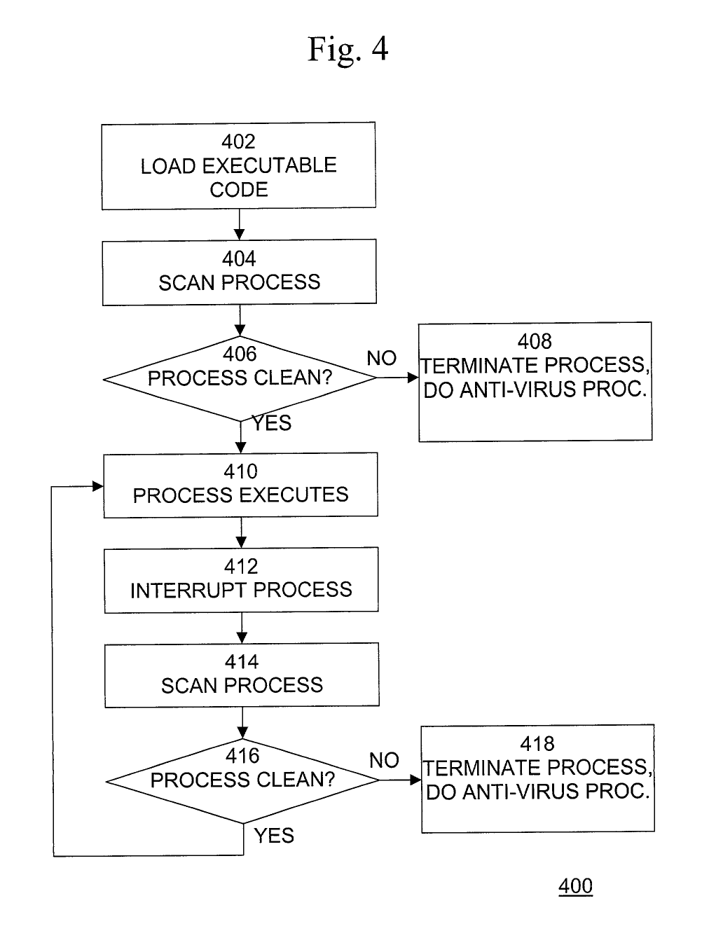

An exemplary flow diagram of a file scanning process 400, which may be implemented in the system shown in FIG. 3, is shown in FIG. 4. FIG. 4 is best viewed in conjunction with FIG. 3. Process 400 begins with step 402, in which executable code for process 210 is loaded by the operating system into main memory from one or more of process files 208A-Z. Process files 208A-Z include executable code and data that are used to created and support the execution of process 210 in main memory of a computer system. Some process files, such as process files 208A and 208B may include uncompressed code and/or data, while other process files, such as process files 208C-Z may include compressed or packed code and/or data. Initially, the operating system loads the contents of one or more process files 208A-Z into main memory, decompressing or unpacking compressed process files as necessary.

In step 404, once an initial amount of executable code has been loaded into main memory, anti-virus program 202 scans the areas or areas in main memory that are included in process 210, in order to determine whether there are any viruses or other malwares present. In step 406, it is determined whether process 210 is clean, that is, there are no viruses or other malwares present in the main memory areas included in process 210. If, in step 406, it is determined that process 210 is not clean, then process 400 continues with step 408, in which process 210 is terminated and other anti-virus processing is performed. The other anti-virus processing may include actions such as quarantining, cleaning, or deleting the files in which the executable code for process 210 is stored.

Steps 404-408 would be useful if the initial executable code for process 210 was stored in a compressed format. However, if the initial executable code for process 210 was not stored in a compressed format, this initial scan would be less useful because anti-virus program 202 would likely have scanned the files in which the initial executable code for process 210 was stored and detected any malwares included in the file. Thus, for initial executable code for process 210 that was not stored in a compressed format, the initial scan would likely always be negative. In this case, steps 404-408 can be skipped and step 410 can be performed immediately after step 402.

If, in step 406, it is determined that process 210 is clean, or if step 404-408 are skipped, then process 400 continues with step 410, in which, execution of process 210 is initiated. Once execution of process 210 has begun, process 210 may load the contents of other process files 208A-Z into main memory. For those process files that are compressed, such as process files 208C-Z, the file contents will be decompressed or unpacked, and in some cased decrypted, before the file contents are available in main memory. Since the process files may contain viruses or other malwares, in step 412, process 210 will be interrupted one or more times at a point at which it is likely that any decryptors and decompressors have run and loaded the file contents into main memory, but at a point before any malwares in the loaded code have had a chance to perform any malicious or unauthorized actions.

Once process 210 is interrupted, then in step 414, anti-virus program 210 will use virus scanning routines 204 to scan the memory space of process 210 for viruses or other malware using existing or new memory scanning techniques. For example, virus scanning routines 204 may scan MICROSOFT MSDOS® memory as well as 32 bit and 64 bit memory under MICROSOFT WINDOWS 95® and MICROSOFT WINDOWS NT®. The decrypted or decompressed code must be present in the memory space of process 210, which enhances the likelihood of finding any virus or other malware that is present. In step 416, it is determined whether process 210 is clean, that is, there are no viruses or other malwares present in the main memory areas included in process 210. If, in step 416, it is determined that process 210 is not clean, then process 400 continues with step 418, in which process 210 is terminated and other anti-virus processing is performed. The other anti-virus processing may include actions such as quarantining, cleaning, or deleting the files in which the executable code for process 210 is stored.

If, in step 406, it is determined that process 210 is clean, then process 400 continues with step 410, in which execution of process 210 continues. Thus, steps 412-416 may be repeated.

One possible point at which any decryption, decompression, or unpacking have been completed, and the process's normal execution is about to start, is when the process accesses files that are not needed to perform the decryption or decompression. For example, these files could be system libraries that a back door Trojan horse program may use to establish a communication link with another computer. As another example, the files could be executable files that a virus is about to infect. Files that process 210 is allowed to access will be those files that all processes access, or those that are determined to be safe. These characteristics will be determined on case by case basis depending upon the operating system in use.

The process of analyzing file system activity to determine when it will be useful to scan a process's memory space can be added to existing on-access file scanning of anti-virus programs. The on-access scan monitors when processes start and sees all the file activity performed by all processes in the system. The on-access scan is thus in an ideal position to scan a process's memory space.

Other techniques can be used to determine when it will be useful to scan a process's memory space. For example, a scan may be initiated when process 210 attempts to access system configuration data, such as the WINDOWS® registry. As another example, a scan may be initiated when process 210 attempts to establish a network or other communication connection.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of detecting a malware comprising the steps of:
interrupting execution of a process that has been loaded for execution;
scanning the process for a malware;
allowing the process to execute, if no malware is found; and
terminating execution of the process, if a malware is found.

2. The method of claim 1, wherein the process is associated with an application program.

3. The method of claim 1, wherein the process is loaded from at least one compressed, packed, or encrypted file.

4. The method of claim 1, wherein execution of the process comprises the step of:
loading code for execution by the process from at least one compressed, packed, or encrypted file.

5. The method of claim 4, wherein the step of interrupting execution of the process comprises the step of:
interrupting execution of the process when the process accesses at least one file that is not needed to perform decryption, decompression, or unpacking.

6. The method of claim 5, wherein the at least one file that is not needed to perform decryption, decompression, or unpacking comprises a system library file.

7. The method of claim 5, wherein the at least one file that is not needed to perform decryption, decompression, or unpacking comprises an executable file not related to the process.

8. The method of claim 5, wherein the at least one file that is not needed to perform decryption, decompression, or unpacking comprises a data file not related to the process.

9. The method of claim 5, wherein the malware is a computer virus.

10. The method of claim 5, wherein the malware is a computer worm.

11. The method of claim 5, wherein the malware is a Trojan horse program.

12. The method of claim 5, further comprising the step of:
scanning the process for a malware before execution of the process.

13. A system for detecting a malware comprising:
a processor operable to execute computer program instructions;
a memory operable to store computer program instructions executable by the processor; and
computer program instructions stored in the memory and executable to perform the steps of:
interrupting execution of a process that has been loaded for execution;
scanning the process for a malware;
allowing the process to execute, if no malware is found; and
terminating execution of the process, if a malware is found.

14. The system of claim 13, wherein the process is associated with an application program.

15. The system of claim 13, wherein the process is loaded from at least one compressed, packed, or encrypted file.

16. The system of claim 13, wherein execution of the process comprises the step of:
loading code for execution by the process from at least one compressed, packed, or encrypted file.

17. The system of claim 16, wherein the step of interrupting execution of the process comprises the step of:
interrupting execution of the process when the process accesses at least one file that is not needed to perform decryption, decompression, or unpacking.

18. The system of claim 17, wherein the at least one file that is not needed to perform decryption, decompression, or unpacking comprises a system library file.

19. The system of claim 17, wherein the at least one file that is not needed to perform decryption, decompression, or unpacking comprises an executable file not related to the process.

20. The system of claim 17, wherein the at least one file that is not needed to perform decryption, decompression, or unpacking comprises a data file not related to the process.

21. The system of claim 17, wherein the malware is a computer virus.

22. The system of claim 17, wherein the malware is a computer worm.

23. The system of claim 17, wherein the malware is a Trojan horse program.

24. The system of claim 17, further comprising the step of:
scanning the process for a malware before execution of the process.

25. A computer program product for detecting a malware comprising:
a computer readable medium;
computer program instructions, recorded on the computer readable medium, executable by a processor, for performing the steps of
interrupting execution of a process that has been loaded for execution;
scanning the process for a malware;
allowing the process to execute, if no malware is found; and
terminating execution of the process, if a malware is found.

26. The computer program product of claim 25, wherein the process is associated with an application program.

27. The computer program product of claim 25, wherein the process is loaded from at least one compressed, packed, or encrypted file.

28. The computer program product of claim 25, wherein execution of the process comprises the step of:
loading code for execution by the process from at least one compressed, packed, or encrypted file.

29. The computer program product of claim 28, wherein the step of interrupting execution of the process comprises the step of:
interrupting execution of the process when the process accesses at least one file that is not needed to perform decryption, decompression, or unpacking.

30. The computer program product of claim 29, wherein the at least one file that is not needed to perform decryption, decompression, or unpacking comprises a system library file.

31. The computer program product of claim 29, wherein the at least one file that is not needed to perform decryption, decompression, or unpacking comprises an executable file not related to the process.

32. The computer program product of claim 29, wherein the at least one file that is not needed to perform decryption, decompression, or unpacking comprises a data file not related to the process.

33. The computer program product of claim 29, wherein the malware is a computer virus.

34. The computer program product of claim 29, wherein the malware is a computer worm.

35. The computer program product of claim 29, wherein the malware is a Trojan horse program.

36. The computer program product of claim 29, further comprising the step of:
scanning the process for a malware before execution of the process.
